(19) United States
(12) Patent Application Publication
(10) Pub. No.: US 2008/0035650 A1
(43) Pub. Date: Feb. 14, 2008

(54) Paint bucket with ledges

(76) Inventor: Jean Victoria Rittmann, Everett, WA (US)

Correspondence Address: Jean V. Rittmann, 2016 Broadway Ave, Everett, WA, 98201-2318, US

(21) Appl. No.: 11/906,985

(22) Filed: Oct. 5, 2007

Related U.S. Application Data
(63) Continuation-in-part of application No. 11/286,975, filed on Nov. 28, 2005.

(51) Int. Cl. B05C 21/00

(52) U.S. Cl. 220/570; 220/505; 220/735

(57) ABSTRACT

This invention is an injection-moldable, substantially rectangular lipped paint bucket, with opposite-side, substantially parallel-edged ledges, ledges formed from the walls beneath the rectangles opposite-side narrower sides. In one embodiment, the first ledge is substantially 0.5 to 0.7″ down from the bucket lip. the second ledge is substantially 2″ down from the bucket lip. These ledges are formed substantially as upside-down L-shaped indentations in the bucket's narrower sides. Each ledge edge protrudes substantially 1″ into the bucket, and is substantially 6″ wide. The first ledge is for brush wiping below the bucket lip. The second ledge, along with the bucket lip rim on the opposite side, is for brush support. The second ledge doubles as a handle.

### CROSS-REFERENCE TO RELATED APPLICATIONS

application Ser. No. 11/286,975 PAINT BUCKET 2005 NOV. 28

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION

This invention relates to receptacles with container attachment or adjunct. More specifically, to receptacles (paint buckets) including edge for removing excess material (i.e. scraper) with tool or brush holder.

Paint buckets up till now have almost always been needed/used in some fashion for brush dipping, brush wiping, and brush holding. It is desirous to comfortably hold or support a bucket while in use; to have an easy-to-dip-into bucket; to have a means to keep a paint implement out of the paint; to have a means to keep the rim clean and paint from dripping out of the bucket; to compactly stack buckets to reduce shipping costs and shelf space; and to have the bucket to be easily cleanable. Additionally pouring from and sealing a bucket would be benefits. It is a crowded art, yet prior art buckets have not yet fulfilled all these basic needs with a single bucket.

Round (at lip and base) buckets are common prior art. Perhaps most buckets were round because metal-formed cans and buckets were easiest to make round, perhaps many expect them to be round. However, round-lipped containers limit the dipping area of paint brushes, which are flat-sided. This problem is most obvious when one tries to dip a 4″ wide brush in a 1 gallon paint can that averages a 5.5″ inside diameter, like that shown in Prior Art FIG. X3 (a 4″ brush in use on a 1 gal can of paint, front perspective view (correct proportions drawn from a photograph)(can walls are cylindrical, no taper like injection mold buckets)): The brush virtually has to be dipped straight down from the top of such a can, which likely requires sitting a can down. Often when painting, sitting a can down on a stable surface while painting is not an option. One can tilt the can gripping the wire handle-and-cans-side, but this is only bearable if the can is mostly empty. Wiping a flat-sided brush on a round rim leaves the brush with an uneven load of paint. Often one tries to wipe nearly horizontal to more evenly wipe paint, but this often leaves paint in the sealing groove. Laying the brush on a cans top lip drips paint out of the can, leaves the lip groove full of paint, gets the handle messy with paint, spills paint out of the can, and is not always a secure place for the brush. Cleaning the groove for a good can seal is very time-consuming.

Noted is U.S. Pat. No. 3,595,431 by Francis L. Bird, granted Jul. 27, 1971, entitled DRIPLESS PAINT CONTAINER, which shows a circular-lipped container. In his abstract he states, “molded plastic paint container” with “two snap-on wire rods in diametrically opposed parallel relation to serve as wipers for the brushes enabling drainage of excess paint therefrom without any spillage. These rods also serve as shelves on which to rest the brush or brushes when not in use.” P. 1, lines 2-3, he states; “its principal object . . . low cost”.

Wire rods in his plastic bucket requires additional labor and expense beyond a basic bucket. Such rods (if not made of expensive stainless steel) can eventually rust (with latex paint) even if galvanized, as wiping is surface-abrasive. Also, a latex paint manufacturer could not sell their product in such a bucket because of the rustable rods. Because the container has a substantially round lip and base, the inside rods further restrict the usable dipping area. Though Francis does not state size, his drawing FIG. 3 shows his bucket with a brush (an average house paint brush is 10″ to 11.5″ long). So his bucket has an approximate 8″ diameter lip and 6″ diameter base, which is a larger opening than a 1 gallon can. His bucket in use is drawn in PRIOR ART FIG. X1, a front view. To use the rods as wipers/brush shelf, his container could only contain (below wipers) perhaps ¾ gallon. The rods, at center, extend about 1″ into the container. (Rod length is around 4″, likely to allow wiping of up to a 4″ brush.) [If the rods were longer they would really restrict the container area for dipping.] A 4″ brush could be wiped (though one would have to pay attention that it is centered on the rod). Tipping the bucket to dip (to get the last of the paint) in his bucket requires maneuvering around the closest rod. A smaller disadvantage is with a buckets metal handle. Because the handle must lay close to the bucket side when not in use, the handle is not very tall when used to hang the bucket. In fact, it is short enough to further restrict the area available for brush dipping. The handle is curved at the top, which is not a comfortable design for a hand that holds it.

A greater problem arises if his rods are used as a brush shelves. This is depicted in my redrawing of his FIG. 2 as my PRIOR ART FIG. X2, top view. A 4″ brush and a 2″ brush are drawn. Note that a 4″ brush could not stay on his ledge, because the containers curved walls pushes it to the brush tip. Brushes have flex, and a heavy wet brush nearly requires likely a full inch of support at the tip to not fall off. Even a 2″ wide brush will barely stay on his ledge with only about 0.5″ of support. Some bristles can split off below the rod. Though only about 1″ into the bucket, the rods restrict the brush dipping area. His container leaves substantially a 6″ rectangular-like area from which to dip a brush, only slightly larger than a gallon paint can. However, if the rods were inside far enough to hold a brush, the buckets dipping area would be 4″, which would be uncomfortable to maneuver around (see vertical phantom lines).

U.S. Pat. No. 4,927,046 by Robert E. Armstrong, granted May. 23, 1990, entitled HOLDING VESSEL WITH SUPPORTIVE HANDLE has a ledge to hold brush bristles and has oppositely-positioned center spout notch to hold brush neck. It's pentagonal shape likely an effort to elongate the container to hold a brush from handle ledge to handle. But the pentagonal shape makes brush wiping on a lip difficult, because a user is comfortable wiping straight in, where his FIG. 1 ¾ center spout/notch is. A painter would either accidentally drip paint out where that notch is or would have to cock their wrist to wipe it on the closer ledge. Though Armstrong comments (P. 3, lines 67-68), “The spouts 3 are further adaptable to pouring liquids accurately”, the somewhat capillary action of the notch actually holds paint at the edge causing drips. The center spout notch also reduces the likelihood that a lid could seal the vessel. The small size of his vessel filled with paint is of advantage, as the sharp edges of FIG. 4 handle 2 (needed for strength) would dig more into a users hand when gripped. Holding a container on its side (like his) requires much more effort and twist-wrist strain than hanging a vessel or tilt/grabbing it near its lip. The handle requires his vessel to be made of a 3-part mold (2 sides of handle/vessel, and interior cavity/core). Adding a slide to a tool adds expense. His handle, shown as two means of holding, teaches away from using the underside of the ledge as a handle or container holding means. And it is virtually impossible to spread one's fingers like Spock (two on one side of the handle, two on the other) and grip under his shelf/ledge. Also, in use, the notch and rim get paint on them. His container might somewhat keep paint off the handle (therein essentially off user's hand) by supporting the brush nearer the neck, not the end of the handle, but paint still can get on the brush above the ferrule.

Though paint brushes are rectangular, and a rectangular container would more easily avail paint for use, both Armstrong and Bird teach away from that shape, perhaps because round shaped containers have almost always been used for painting with brushes. (A pentagonal shape is substantially round compared to a rectangular shape). Prior art rectangular-lipped molded plastic containers include plastic food containers, and some bathroom wastebaskets. Rectangular-lipped food containers with rounded corners allow for a secure seal with a lid.

Most importantly, Bird and Armstrong's containers cannot be stacked sufficiently one-inside another to reduce space. That is, buckets are low ticket items, so large quantities must take up a minimal amount of space when shipped and shelved in stores. Bird's bucket, even if rods were shipped separately, cannot be stacked one closely inside another because of the rod supports. Armstrong's handle prevents stacking of his container.

Large plastic totes, like Sterilite's 18 gal tote model 603171BL have opposite-side indentations (that interiorly look like round mounds) that are for handles. Another tote with indentations is seen at globalindustrial.com is 744171 which is size 16.3″ L×11.5 W×5.8″ H. Utility of indentations is for a user to cup their fingers of each hand under opposite side indentations such that the tote can be carried between the user's arms. Because of the large size and weight of the totes, and somewhat because of the shape of the indentations) the tote cannot be lifted easily by grasping just one side of the tote under the handle. The handle/ledges are positioned up high on the tote for the second benefit of mating with the opposite-side lid handles. The tote is of a size that a 9″ roller would roll horizontally in the tote. And some (9″ rollers have extension handles that might extend the 16″ horizontal width of the tote/box. However the interior side of a handle/mounds is not wide/flat enough into the bucket enough to support the cylinder of the roller on it, and it is too long to support a brush handle on the opposite side of the handle.

Prior art paint brushes (2″ to 4″ wide) are of average 9″ to 11″ brush tip to handle end. 3″ and 4″ wide (2″ diameter) roller handles average 10″ to 11.5″ from roller barrel to handle tip. Prior art 9″ (2″ diameter) roller handles average 12″ to much longer extended handles from roller barrel to handle tip.

U.S. Pat. No. 5,8110,196 by Michael J. Lundy, granted Sep. 22, 1998, entitled PAINT BUCKET, and U.S. Pat. No. 4,164,299 by Patti S. Fuhr, granted Aug. 14, 1979, entitled TRAY FOR PAINT AND BRUSHES show a separate compartment to stand a brush upright while not in use. Sur-line pail # 12300, a 5 qt. bucket, also shows a separate compartment to hold a brush. Shur-line's has roller grid up one side of the bucket that slants into the bucket, and bottom extensions beneath it. All the pail's compartments and corners make for difficulty cleaning. As pressure must be placed on the grid side of the pail when rolling a roller on it, the bucket would easily tip, so one substantially needs to use a second hand to secure the pail, so painting standing up requires bending over to hold the pail. Brush painting (versus 9″ roller painting) is usually done with the pail close to the user. So a user must lift the brush into a vertical position to put it in the second compartment. The non-compartment side of the paint pail is usable when closest to the user, so a user must reach over and vertically place the brush in with every stopped use. There is a hole where the roller handle can sit to keep roller out of paint so roller won't soak therein drip. For the roller to be hung inside the pail but not in the paint, the pail must be about ⅔ empty. Because the bucket is tall and deep, a brush painters hand is more likely to get paint on it, especially if roller and brush used alternately.

Lundy's bucket could have the effect of Bird's rod in holding brush bristles (but for the bucket being way too long). However having a pouring spout where the handle would lay is where paint would be, which would make the handle gooey with paint. The depth of his brush holding compartment makes the distance even longer and absurdly impossible.

Other prior art brush holding means include magnets, where the brush needs positioned just so and the bucket is to be held to pull the brush off to not spill paint. Also, paint can get on the ferrule, which is unpleasant at best. Paint on ferrule and magnet side also reduces magnet effectiveness.

### BRIEF SUMMARY OF THE INVENTION

This invention is an injection-moldable, substantially rectangular lipped paint bucket, with opposite-side, substantially parallel-edged ledges, ledges formed from the walls beneath the rectangles opposite-side narrower sides. In one embodiment, the first ledge is substantially 0.5 to 0.7″ down from the bucket lip. the second ledge is substantially 2″ down from the bucket lip. These ledges are formed substantially as upside-down L-shaped indentations in the bucket's narrower sides. Each ledge edge protrudes substantially 1″ into the bucket, and is substantially 6″ wide. The first ledge is for brush wiping below the bucket lip. The second ledge, along with the bucket lip rim on the opposite side, is for brush support. The second ledge doubles as a handle.

### ADVANTAGES OF THE INVENTION

The first ledge lets a painter wipe a brush slightly down and away from the lip, to keep the lip clean for a lid or brush handle. The ledge is wide enough to wipe even a 4″ brush without paying much attention. The ledge tilts to allow paint to drip back in the bucket. One can pour paint from that side's corners.

The second ledge is wide and deep enough to easily lay flat even 4″ wide brushes. It is down about 1.75″ to 2″ to lay a brush bristles in the bucket without dripping paint outside the bucket. (Brush handle lays on opposite-side bucket lip rim.) The second ledge is either flat or declines away from the buckets center to help keep the brush from slipping off.

The buckets rectangular shaped lip and body easily allows a wide (like 4″) brush to be dipped while holding the buckets handle. The bucket can also be tilted (to get the last of the paint) by grabbing under the second ledge and above the same-side lip, like a handle. An average bucket can hold a gallon of paint below the lowest ledge (so it is always useable). Ledges formed as upside-down L-shaped indentations in a bucket are as easy to injection mold as common prior art plastic buckets. Because there are no extra parts (like metal rods), a paint manufacturer could sell their product in the bucket. The wiping/resting ledges average 6.25″ wide, so one doesn't have to maneuver a brush to wipe it, like if the ledge were only the exact width of the brush.

Holding a bucket by prior-art style metal handle is the most stress-free way of holding a bucket. With my bucket there's lots of room to dip a brush while hanging from the handle (because any bucket handle must lay substantially against the bucket side when not in use). This buckets handle is taller and flatter at the top than prior art buckets. A longer handle makes the buckets dipping area larger. Holding the flat handle is easier. [In contrast, prior art bucket openings are smaller/restrictive, and they often must be tilted to dip inside, which is strenuous on the wrist.] A 4″ painting grid can fit in my bucket because of the square lip and close-to-the-top first ledge. The rectangular shape is best for rollers, which are wide. The bucket is as easy to use by both left-handed and right-handed users (just turn the bucket around). The bucket can be stacked one inside another closely as prior art plain round buckets, which is a most important factor in reducing shipping costs and shelf space. Laying a brush down on/in the bucket is a more convenient position to leave a brush, as it requires no wrist twisting like second-compartment brush supports. Adding a roller grid versus making the grid part of the bucket allows for stable weight balance in the bucket and for more paint to be filled in the bucket. Laying a brush from right rim to left ledge is most advantageous because first ledge keeps the right rim clean and exact brush positioning is not required. That is, the first ledge and second ledge work together: keeping paint off a brush handle when brush bristles are positioned on the second ledge. A bucket design that allows for a sealing lid lets a painter go to lunch or come back the next day and continue painting without emptying and cleaning the bucket. The bucket has a single open area for paint, which makes cleaning the bucket easier.

### BRIEF DESCRIPTION OF THE DRAWINGS

PRIOR ART FIG. X1 is Bird's bucket in use, front view.

PRIOR ART FIG. X2 is Bird's bucket in use as a ledge, top view.

PRIOR ART FIG. X3 is a 4″ brush on a 1 gal can, front perspective view.

FIG. 1 is the embodiment, user dipping brush & hung, front view.

FIG. 2 is the embodiment, prior art brush laying on a ledge, front view.

FIG. 3 is the embodiment, user gripping ledge & handle, front view.

FIG. 4 is the embodiment with a prior art brush, top view.

FIG. 5 is the embodiment gripped & w/brush, front view.

FIG. 6 is the embodiment with a prior art roller grid, top view.

FIG. 7 is the embodiment, RHS view.

FIG. 8 is the embodiment, LHS view.

FIG. 9 is the embodiment, front view.

FIG. 9D1 is a detail of the embodiment shown in FIG. 9.

FIG. 9D2 is an alternative lip embodiment, same view as FIG. 9D1.

FIG. 10A is a substantially rectangular-bottomed embod., bottom view.

FIG. 10B is a substantially elliptical-bottomed embod., bottom view.

FIG. 11 is the embodiment, top view.

FIG. 12 shows two buckets stacked one inside another, front view.

FIG. 13 shows a roller positioned on an embodiment laying down

FIG. 14 shows a roller positioned on an embodiment standing up

FIG. 15 shows vertical cross-section of embodiment 10A, front view.

FIG. 16 is an alternative style embodiment, top view.

FIG. 17 is an alternative style embodiment, for 9″ roller, top view.

### BRIEF DESCRIPTION OF THE NOTATIONS

L = left, R = right, F = front, B = back, M = middle,
C = corner, U = upper, D = lower

| | |
|---|---|
| 1 | lip |
| 2 | vertical cross-section |
| 4 | prior art grid |
| 5 | front/back side walls |
| 6 | left/right side walls |
| 7 | ledges |
| 8 | ledge edge |
| 9 | bottom |
| 10 | rim |
| 11 | handle supports |
| 12 | handle |
| 13 | a front-to-back depth |
| 55F | a grid pattern |
| 66L | a second ledge |
| 66R | a grid pattern |
| V1 | a ledge bump |
| P1 | a pocket |

### DETAILED DESCRIPTION OF THE INVENTION

### 1. Description of One Embodiment of the Invention

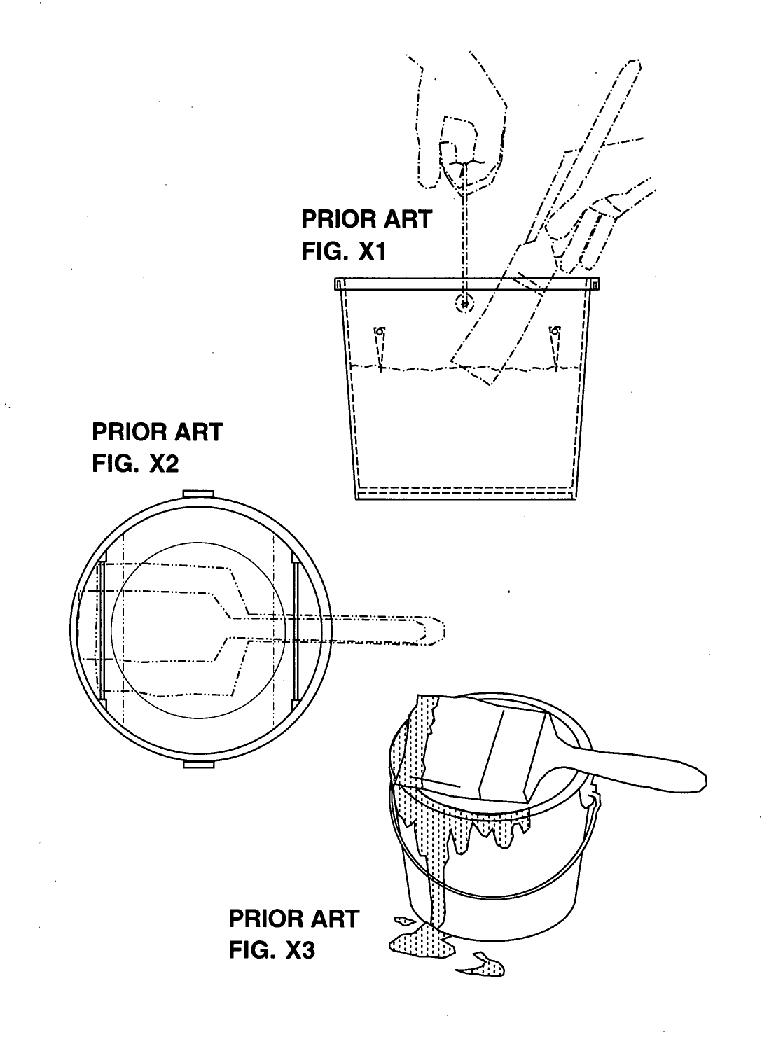

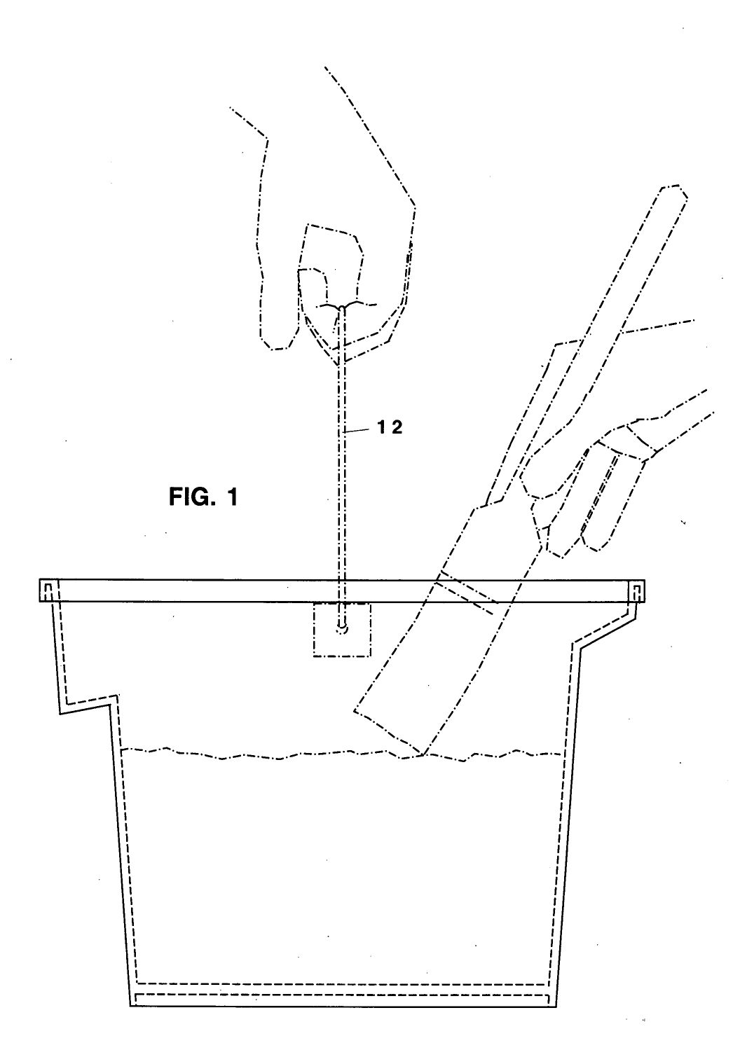

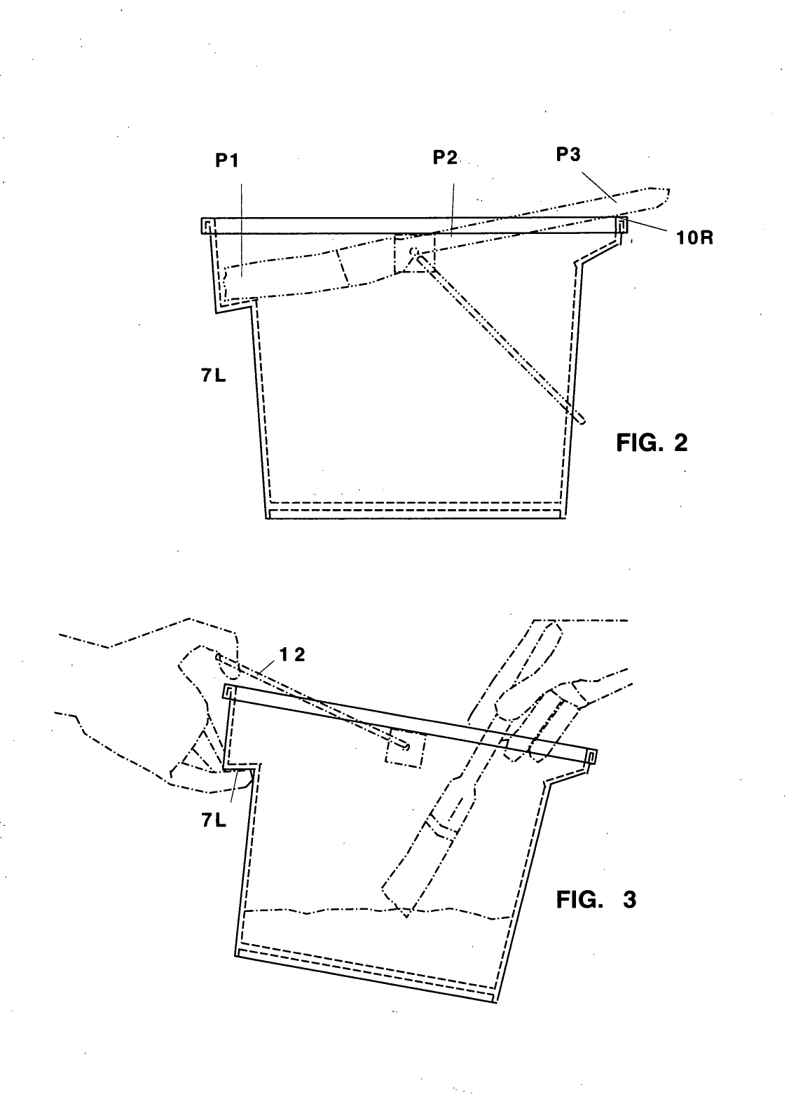

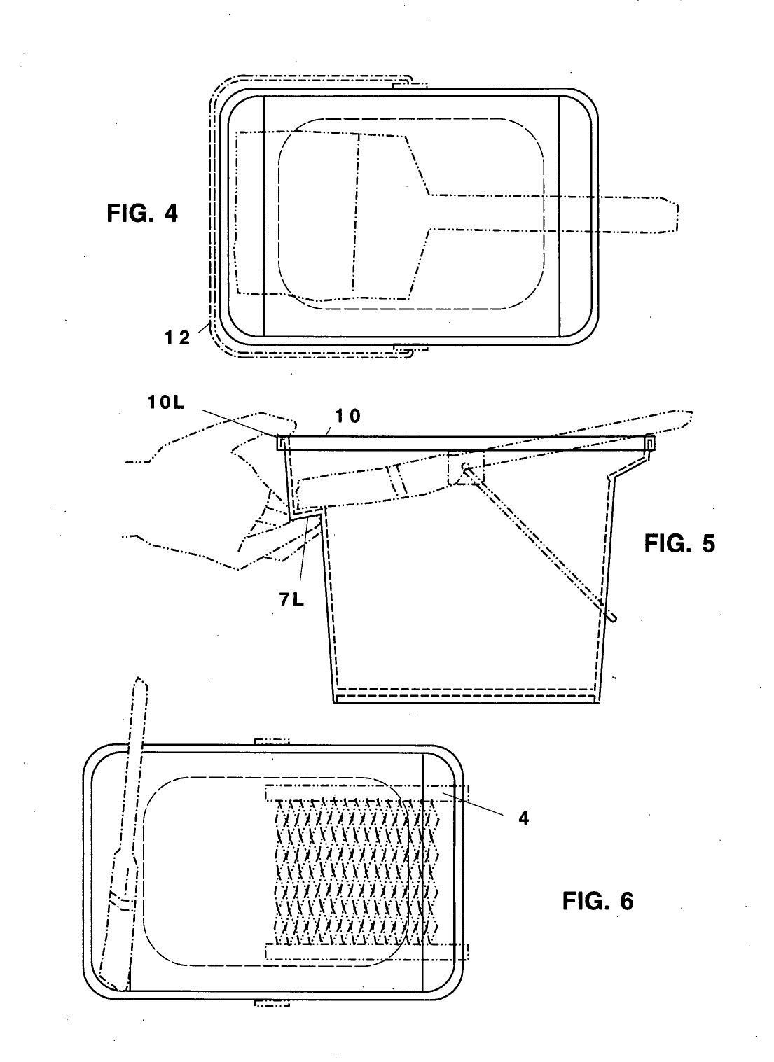

FIGS. 1-6 show an embodiment of the invention in various uses. FIG. 1 is the embodiment, front view, user dipping brush in the wide open bucket. The bucket is hung from a users hand. The top of handle 12 is about 1″ farther away from the buckets rim than a prior art bucket/can of the same gallon-holding size. This is because the lip is larger than other gallon-sized prior art round buckets/cans. The handle (best shown in FIG. 4 as notation 12) is substantially rectangular, like the bucket lip. The handle is longer so it can lay substantially against bucket walls when not in use (like in FIG. 2). The longer handle adds to the open area for brush dipping. Its flat top-portion is more comfortable on the hand to grip than round-topped handles.

FIG. 2 is the embodiment with a prior art brush bristles P1 laying on a ledge and the brush handle P3 laying on the right lip rim portion 10R, front view. Prior art brush neck is notated as P2. The brush bristles lay down flat side on second ledge 7L and the handle lays on opposite-side lip rim 10R. The distance between upper portion of the left side and said right lip rim portion is of a length to support brush bristles on the second ledge and brush handle on said right lip rim. FIG. 3 is the embodiment with a user gripping under second ledge 7L and handle 12, front view. The user is tilting the bucket and dipping a brush to get the last of the paint. FIG. 4 is the embodiment with a prior art 4″ brush, top view. These ledges are formed substantially as upside-down L-shaped indentations in the bucket sides under rectangle shorter sides, and in this embodiment look like upside-down L's when viewed facing said front side or back side wall.

FIG. 5 is the embodiment gripped by a user between bucket second ledge 7L and lip rim 10 (brush on ledge) front view. FIG. 5 also shows a user grabbing the bucket with fingertips under second ledge 7L and thumb above left side lip rim 10L. FIG. 6 is the embodiment with a prior art 4″ roller grid 4, top view. With substantially straight shorter lip sides, the grid fits nicely in/on the bucket. Having a grid inside the bucket with paint flowing around it allows a user to roll agressively up the grid without worries of tipping the bucket (as Sur-Line's bucket molded-in grid might). FIG. 6 also shows a small and short prior art paint brush with bristles on the second ledge and handle laying on back lip rim portion. This means of supporting a brush utilizes the front side wall portion of the bucket for keeping the brush from moving forward and the back lip rim for supporting the brush handle. The front portion of the ledge is substantially parallel with the back lip rim, therein its utility is substantially similar. The curvature of the bucket front-left and left-back corners reduce the ledge's and lip rim's usable width.

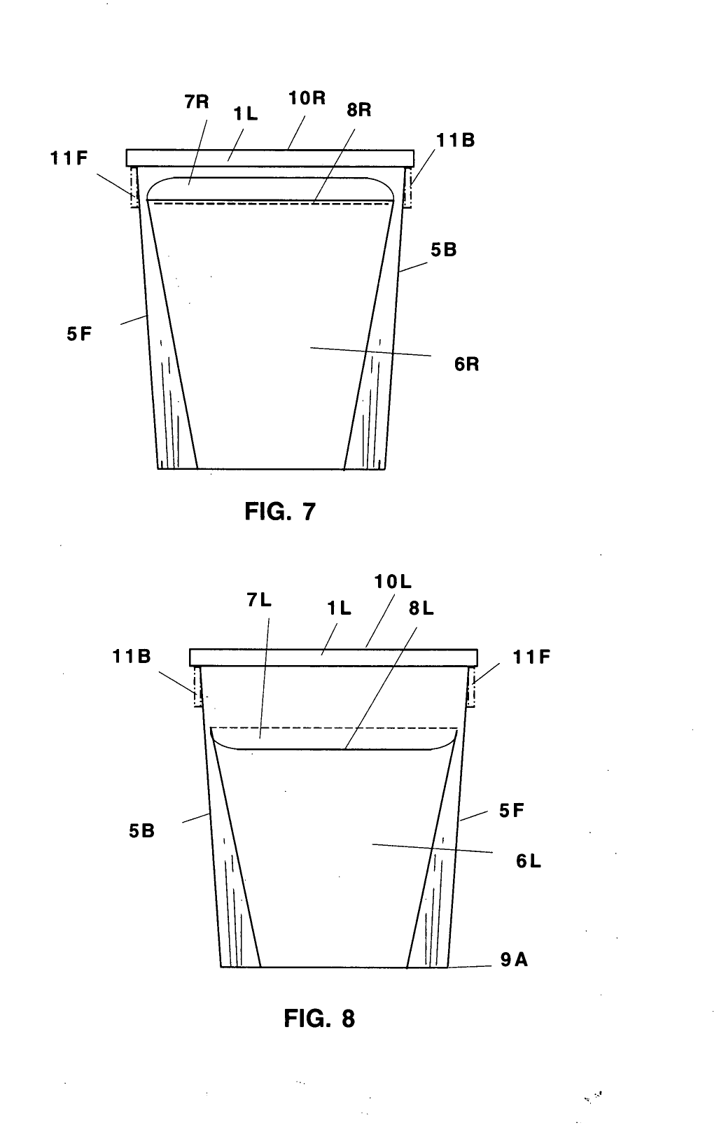

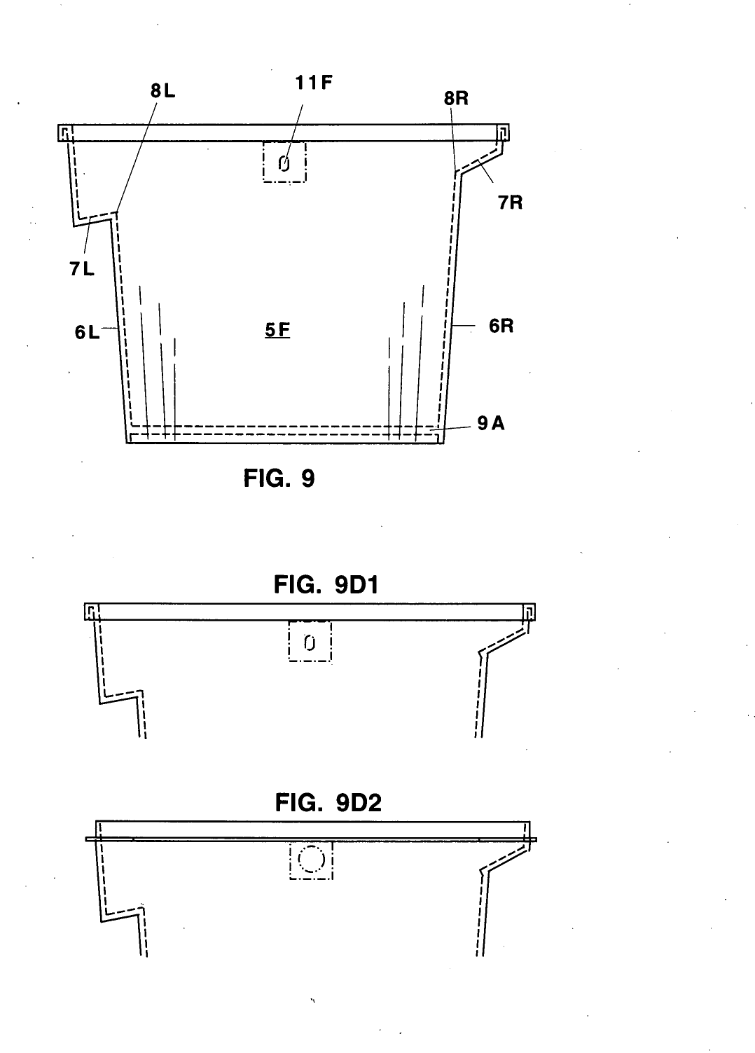

FIG. 7 is the embodiment, RHS view. Handle supports 11F and 11B, right side lip 1R and right lip rim portion 10R, right side wall 6R, front and back side walls 5F and 5B, first ledge 7R, and first ledge edge 8R are noted. FIG. 8 is the embodiment, LHS view. Handle supports 11F and 11B, left side lip 1L and left lip rim portion 10L, left side wall 6L, front and back side walls 5F and 5B, second ledge 7L, second ledge edge 8L, and bottom 9A are noted. FIG. 9 is the embodiment, front view. Handle support 11F, left and right side walls 6L and 6R, front wall 5F, second ledge 7L, first ledge 7R, second ledge edge 8L, first ledge edge 8R, and bottom 9A are noted. FIG. 9D1 is a detail of the embodiment shown in FIG. 9. Handle attachment ends, that hook into bucket, can be made in a variety of prior art ways (none shown). The supports can be made integral with the lip. FIG. 9D2 is an alternative lip embodiment, same view as FIG. 9D1. FIG. 9D2 shows a prior art lip like that used in a round-cornered rectangular-lipped container, like Tupperware®: a lip designed to mate with a lid. This figure shows a prior art knob for a loop-ended wire handle (wire ends curve around knob)[not shown]. Other prior art ways of supporting a handle are not discussed.

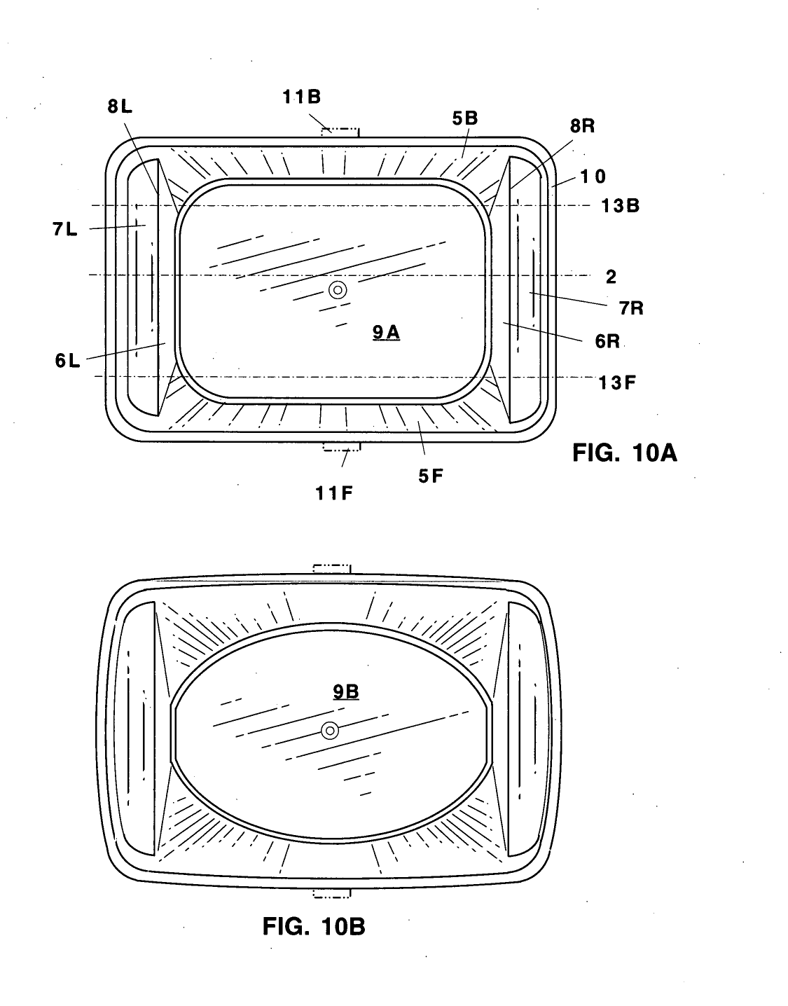

FIG. 10A is a substantially round-cornered rectangular-bottomed embodiment, bottom view. The bottoms center indicates a circular injection-molded gate site. Handle supports 11F and 11B, left and right side walls 6L and 6R respectively, front and back side walls 5F and 5B respectively, second ledge 7L, first ledge 7R, second ledge edge 8L, first ledge edge 8R, and bottom 9A are noted. FIG. 10B shows a substantially elliptical-bottom 9B embodiment, bottom view. Its elliptical-bottom shape adds an aesthetic “round” appearance. The left and right side lip rim portions are somewhat curved for a tooling benefit. Still, left and right side lip rim portions are substantially parallel with first and second ledge edges.

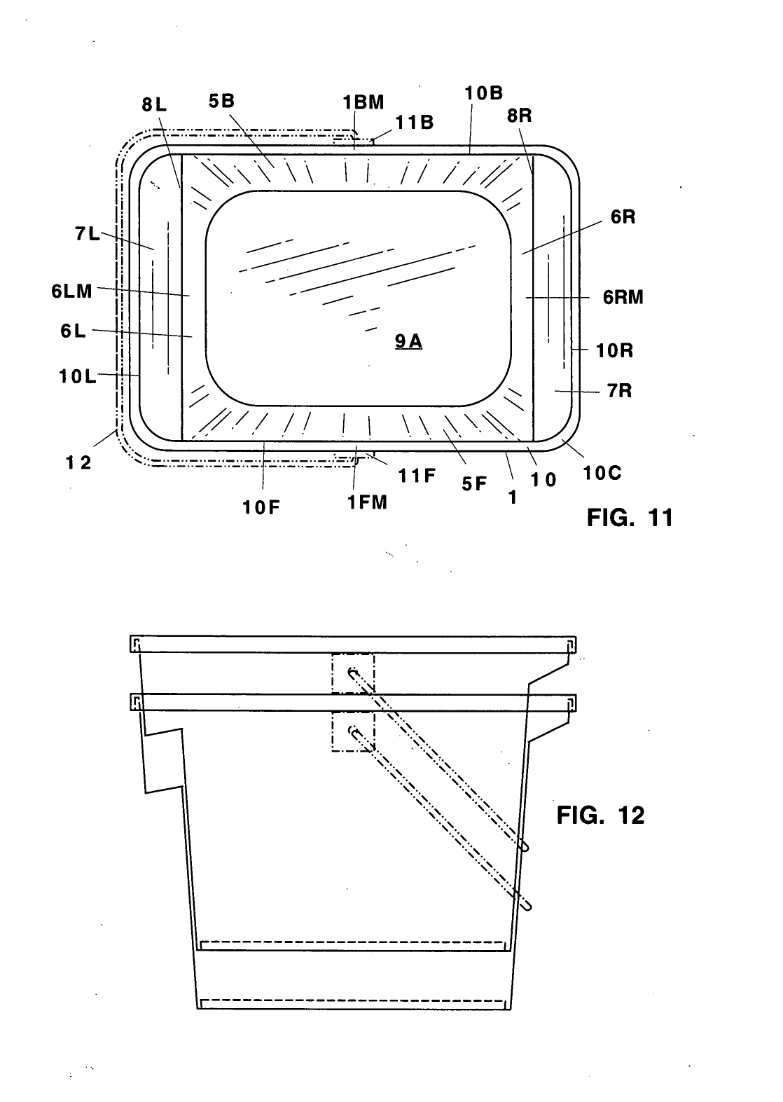

FIG. 11 is the embodiment, top view. The bucket has lip 1 and lip rim 10. The lip rim is substantially rectangular with rounded corners, like corner 10C. The lip rim is shown as an inside-bucket lip line. The cross-section has opposite-side longer lip rim portions 10L and 10R (left side and right side lip rim portions respectively). The cross-section shows opposite-side lip rim portions 4L and 4R. The bucket extends downward from the lip, which is substantially the upper (like upper 0.25″) portion of the bucket.

The embodiment has opposite-side (wider) front and back side walls 5F and 5B, each positioned beneath opposite-side lip rim longer portions. The bucket has opposite-side (narrower) left and right side walls 6L and 6R, each positioned beneath opposite-side lip shorter portions.

The bucket has two opposite side ledges 7L and 7R. The ledges each have a substantially straight horizontal edge (edge 8L and 8R) positioned inside the bucket. The ledges each substantially position beneath and substantially parallel with the shorter sides of the lip (best seen in FIG. 9).

A substantial portion of each ledge edge protrudes at least ¾ inch horizontally centrally into the bucket from a corresponding lip shorter side. In this embodiment, each ledge protrudes about 1.2″ horizontally centrally into the bucket. The ledges are substantially integrally formed from the buckets narrower side walls, appearing as substantially horizontally-elongated upside-down L-shaped indentations in the narrower side walls (best seen in FIG. 9).

The bucket has circumferentially enclosing side walls 5F, 5B, 6L, and 6R. The bucket has bottom 9 fixedly attached to substantially the bottom edges of all the side walls. The side walls together integrally form circumferentially enclosing side walls. All the side walls have bottom edges. Bottom 9 is fixedly attached substantially to all side wall bottom edges. So together, the bottom and side walls integrally form a container. The side walls are shown (best seen in FIG. 9) extending like 0.2″ below bucket bottom, to improve bucket stability. Such extensions would likely be considered feet rather than walls. The bucket substantially is a single molded unit that can contain liquid. Bucket gallon size can be: lip 10″×7″, bottom: 7″×5.5″, & bucket height: 7″.

The bucket lip has a rim 10, which is the top-most portion of lip 1. In this embodiment, the lip is flat on top. The ledges are right hand side first ledge 7R and a left-hand side second ledge 7L. [Best seen in FIG. 9, the left-hand side ledge edge 8L is substantially 1.5″ to 3″ down from the lip rim. Such a depth is deep enough to keep paint off the left side lip after a brush wet with paint is placed on the second ledge (and handle resting on right side lip rim), and to keep the brush slanted in the bucket, to keep it from sliding off, the ledge should be down substantially at least 1″. The right-hand side ledge edge 8R is substantially 0.25″ to 1.5″ down from the lip rim to keep paint off the lip for a clean bucket seal to a lid.] The bucket bottom is substantially rectangular with rounded corners. The second ledge is positioned substantially down from the left lip rim portion on said left side wall for keeping the bristles lower in the bucket than the handle and for keeping the bristles, when wet with paint, from dripping paint on the lip rim. Keeping left rim portion clean is for best sealing a lid to the lip.

The lips longer sides each have a horizontal middle (middle 1FM and 1BM). In use, the bucket should include a pair of prior art integrally-formed handle supports, like handle supports 11F and 11B. The supports position slightly beneath/directly beneath the lip at corresponding opposite-side horizontal middles 1FM and 1BM. Attached thereto is prior art wire metal handle, like handle 12. The supports are each of a size and shape to support one of two sides of a prior art style wire handle.

FIG. 12 shows two buckets stacked one inside another. Bucket walls are drawn thick in other figures for clarity. Actual wall thickness can average 1-2 mm. The bottom edge of the handle supports rest over the rim of the bucket beneath it, as is the case with many prior art plastic round buckets.

The bucket has a downwardly tapered form to be easily removable from a molding tool. A 5° total grade (includes both sides) is average for buckets that stack within each other. The bucket is of a downwardly tapered form to be stackable one said bucket substantially inside an identical bucket.

The bucket may be injection, vacuum-, blow-, or roto-molded. Or other. Though demonstrated for paint, my buckets utility is of benefit for liquids like wallpaper paste, as well as more viscous materials. In example, a smaller bucket of the same shape could be used for spackle (smaller bucket so spackle knife fits across from the second ledge to the opposite-side lip). The bucket can be used by right or left handed users by just turning the bucket around. Materials to make the invention include, but are not limited to be made from polypropylene, HDPE, or other plastics or resins. The lip is the area near the top of the bucket from the rim down. It may include the top portions of the side walls of a size and shape to mate with a lid. Often the lip can be the top quarter inch of the bucket.

All embodiments show a circumferentially-continuous lip rim. The second ledge is of a size and shape to support bush bristles flat side when brush bristles are placed on the second ledge and brush handle is placed on said right rim portion. The first ledge edge of a size and shape to wipe a brush flat-side and is for wiping a brush inside said bucket, for keeping paint off the right lip rim portion, and for keeping paint off a brush handle. The second ledge is horizontal to sloping upward medially, the first ledge is horizontal to sloping downward medially. The distance between upper portion of left side wall and the right side lip rim is less than the total length of a prior art paint brush, which is most often a distance less than 11″

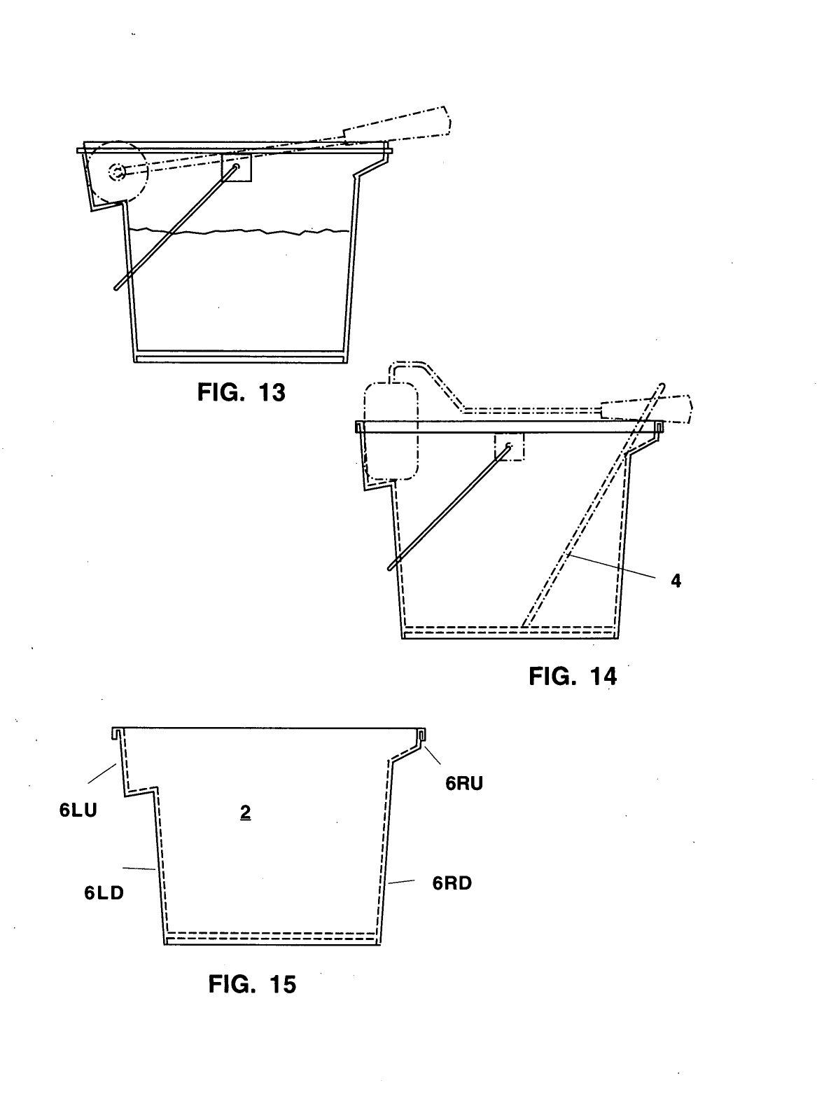

FIG. 13 shows a roller barrel positioned laying down on the bucket's second ledge and roller handle positioned on (opposite-side) right side lip rim bucket front view. A 2″ diameter roller might roll off a 1″ medially-extended second ledge because it is a wheel and because the bucket isn't always level. For this roller position, second ledge is medially extended to at least 1.25″ for a 4″ front-to-back depth. In claims, L-shaped ledge is substantially L-shaped at least 4″ front-to-back side depth (example: FIG. 10 distance 13F to 13B).

FIG. 14 shows FIG. 6 embodiment, front view with a roller barrel positioned upright on the bucket's second ledge and roller handle positioned on right side lip rim. Also, a roller grid 4 is shown inside. Because of left wall taper above second ledge, all wet roller nap stays well inside the bucket.

FIG. 15 shows vertical cross-section 2 of the bucket shown in FIG. 10A (where 2 is horizontal phantom line). The cross-section shows 6LU upper portion of the leftward/peripherally side, which is above the second ledge and dripping paint outside the bucket.

The cross-section shows 6LD lower portion of the left side, which is below the second ledge. The second ledge is sloping/inclining upward medially, for keeping brush bristles or a roller from moving off the ledge. Specification describing the second ledge as upside-down L-shaped includes the description of the lower portion of the left side because it is integral to forming (by injection mould) and supporting the ledge, whereas the upper portion is not. The upper portion of both ledges has other utilities, like for sealing a lid on, keeping the lip clean, and keeping the paint implement on the second ledge from moving off to the left.

The cross-section shows 6RU upper portion of the right side, which is above the first ledge. This right side upper portion is only as tall as what is needed to seal a lid away from the paint, a height of which can be 0.25″ tall. The first ledge is sloping/declining downward medially for allowing paint to drip back into the bucket. The cross-section shows 6RD lower portion of the right side, which is below the first ledge. Specification describing the first ledge as upside-down L-shaped includes the description of the lower portion of the right side.

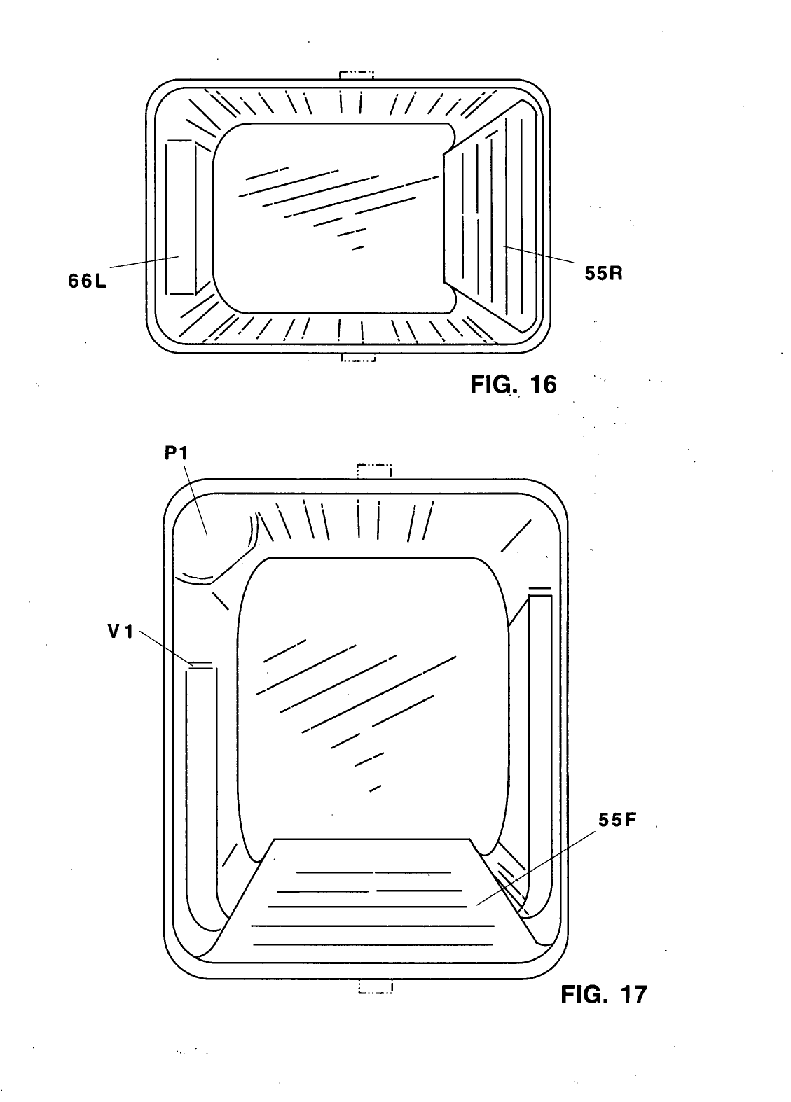

FIG. 16 is an alternative style embodiment, top view. It shows second ledge 66L not extending all the way to the front and back sides of the bucket. It has roller grid 55R. A first ledge can be at the top of the grid.

FIG. 17 is an alternative style embodiment for including a 9″ roller, top view. The bucket embodiment is of a width such that, with the roller barrel or brush tip positioned on second ledge, handle of roller or brush can lay on opposite side bucket lip. The bucket was made wide (front to back) enough for a 9″ wide roller. Roller grid pattern 55F is on the front of the bucket. A second ledge to hold a roller often needs to be at least 1.25″ to hold the roller on a second ledge. Because a molded bucket often uses a taper to pull it out of the tool, and because the left-to-right side distance at the top of the bucket should not be much more than 10″ for most brushes, there may not be enough bucket width to allow a full 1.25″ second ledge AND a 9″ roller space left-to-right side. A pocket P1 may hold a roller barrel vertically, and handle lay on right side lip rim. This would make the bucket at the corners harder to clean. An end-raised second ledge bump like V1 on that back side area may be added to keep a brush from shifting off the second ledge. portion. The embodiment right side shows a roller grid pattern 66R molded as part of the bucket. The front-to-back distance near the bucket second ledge can confine a brush laid flat from shifting front to back. Again, the disadvantage of molding a roller grid on the bucket is pressure on the grid can tip the bucket without bending down to hold the bucket, as compared to a flow-through grid place IN a bucket. The right lip rim is a support means for keeping paint off the brush above the ferrule when the brush is laid flat on the second ledge. The right lip rim portion is of a length to support brush bristles, roller barrel, or implement on said second ledge and brush handle, roller handle, or paint implement on said right lip rim. As 2″-4″ wide brushes and 3″ and 4″ (2″ diameter) rollers can be supported second ledge to right lip rim, for claims and specification they are (paint) implements, where the brush bristles and roller nap end are the painting end. The roller shown in FIG. 14 can also be considered laying flat side on the second ledge, as roller end is flat.

### 13. Conclusion

The invention provides a second ledge for holding a brush, a first ledge for brush wiping, and a rectangular, therein enlarged, area for brush dipping. The bucket can be a one-piece moldable from a 2-part tool. Buckets can be closely stacked, for saving shipping and shelf space. No other buckets, alone or in combination, recognize the ledge, clean rim, dipping benefits or that L-shaped ledges would allow buckets to be easily made and stacked.

I claim:

1. A paint bucket, comprising:
(a) said bucket having an open area for paint; said bucket having opposite-side front and back side walls; said bucket having opposite-side left and right side walls; all said side walls together integrally forming circumferentially enclosing side walls; said bucket having a lip rim; said lip rim having left, right, front, and back portions;
said walls extending down from said lip rim;
said side walls having bottom edges;
said bucket having a bottom;
said bottom fixedly attached substantially to all said bottom edges;
said bottom attached to said side walls integrally forming a container for containing paint;
(b) a second ledge, for laying a paint implement across said bucket on said second ledge and opposite-side said right lip rim portion; said second ledge substantially integrally formed from said left side wall; said second ledge positioned substantially at least 1″ down from said left lip rim portion on said left side wall for keeping implement painting end lower in said bucket than the implement handle when the handle is rested on said right rim portion and painting end are positioned on said second ledge, for laying painting end in said bucket without dripping paint on said rim or outside said bucket; said second ledge protruding substantially at least ¾ inch horizontally centrally into said bucket; said second ledge substantially an upside-down L shaped indentation in said left side wall substantially horizontal to inclining upward medially, for keeping implement painting end from moving medially off said second ledge; said second ledge for a user gripping said bucket between said left lip rim portion and under said second ledge; said second ledge for stacking one said bucket inside another; said left side wall having an upper portion, said upper portion for containing implement painting end positioned on said second ledge from sliding leftward/peripherally and dripping paint outside said bucket;
(c) said second ledge having a horizontal edge; said second ledge edge positioned substantially at least ¾ inch horizontally centrally into said bucket; said second ledge edge substantially parallel with said right lip rim portion; said second ledge edge of a size and shape to support an implement flat-side; and said second ledge edge for supporting implement painting end; said right lip rim portion for supporting implement handle;
(d) and distance between said left side upper portion and said right lip rim portion being of a length to support implement painting end on said second ledge and implement handle on said right lip rim.

2. The bucket according to claim 1, further including:
(d) a first ledge; said first ledge for keeping said right portion lip rim clean; said first ledge for fitting a painting grid in said bucket on said bucket left lip rim portion; said first ledge for stacking one said bucket inside another; said first ledge substantially integrally formed from said right side wall; said first ledge protruding substantially at least ¾ inch horizontally centrally into said bucket; and said first ledge substantially an upside-down L shaped indentation in said right side wall; said first ledge being substantially horizontal to declining downward medially for allowing paint to drip back into said bucket.
(e) said first ledge having a horizontal edge; said first ledge edge positioned substantially at least ¾ inch horizontally centrally into said bucket; said first ledge edge positioned substantially at least 0.25″ down from said right lip rim portion for keeping said right side lip rim clean for sealing to a bucket lid; said first ledge edge substantially parallel with said right lip rim portion; said first ledge edge of a size and shape to wipe a brush flat-side; and said first ledge edge for wiping a brush inside said bucket, for keeping paint off said right lip rim portion, and for keeping paint off an implement handle.

3. The bucket according to claim 1, wherein said first ledge edge substantially positioned 0.5″ to 1.5″ down and said first ledge protruding substantially at least 1 inch horizontally centrally into said bucket.

4. The bucket according to claim 1, wherein said second ledge edge substantially positioned 1.5″ to 3″ down and said first ledge protruding substantially at least 1 inch horizontally centrally into said bucket.

5. The bucket according to claim 1, wherein: said bucket lip substantially rectangular shaped, said rectangular shape for easy dipping of wide paint implements into said bucket; said rectangular shape for laying implement handle on said right lip rim portion.

6. The bucket according to claim 1, wherein: said second ledge protruding substantially at least 1 inch horizontally centrally into said bucket.

7. The bucket according to claim 1, wherein: distance between upper portion of said left side wall and right side lip rim being less than 11″.

8. The bucket according to claim 1, wherein: L-shaped second ledge is substantially L-shaped at least 4″ front-to-back side depth.

9. The bucket according to claim 2, wherein: L-shaped first ledge is substantially L-shaped at least 4″ front-to-back side depth.

10. A paint bucket, comprising:
(a) said bucket having an open area for paint; said bucket having opposite-side front and back side walls; said bucket having opposite-side left and right side walls; all said side walls together integrally forming circumferentially enclosing side walls; said bucket having a lip rim; said lip rim having left, right, front, and back portions;
said walls extending down from said lip rim;
said side walls having bottom edges;
said bucket having a bottom;
said bottom fixedly attached substantially to all said bottom edges;
said bottom attached to said side walls integrally forming a container for containing paint;
(a) a first ledge; said first ledge for keeping said right portion lip rim clean; said first ledge for fitting a painting grid in said bucket on said bucket left lip rim portion; said first ledge for stacking one said bucket inside another; said first ledge substantially integrally formed from said right side wall; said first ledge protruding substantially at least ¾ inch horizontally centrally into said bucket; and said first ledge substantially an upside-down L shaped indentation in said right side wall; said first ledge being substantially horizontal to declining downward medially for allowing paint to drip back into said bucket.
(b) said first ledge having a horizontal edge; said first ledge edge positioned substantially at least ¾ inch horizontally centrally into said bucket; said first ledge edge positioned substantially at least 0.25″ down from said right lip rim portion for keeping said right side lip rim clean for sealing to a bucket lid; said first ledge edge substantially parallel with said right lip rim portion; said first ledge edge of a size and shape to wipe a brush flat-side; and said first ledge edge for wiping a brush inside said bucket, for keeping paint off said right lip rim portion, and for keeping paint off an implement handle.

11. The bucket according to claim 10, further including:
(c) a second ledge, for laying a paint implement across said bucket on said second ledge and opposite-side said right lip rim portion; said second ledge substantially integrally formed from said left side wall; said second ledge positioned substantially at least 1″ down from said left lip rim portion on said left side wall for keeping implement painting end lower in said bucket than the implement handle when the handle is rested on said right rim portion and painting end are positioned on said second ledge, for laying painting end in said bucket without dripping paint on said rim or outside said bucket; said second ledge protruding substantially at least ¾ inch horizontally centrally into said bucket; said second ledge substantially an upside-down L shaped indentation in said left side wall substantially horizontal to inclining upward medially, for keeping implement painting end from moving medially off said second ledge; said second ledge for a user gripping said bucket between said left lip rim portion and under said second ledge; said second ledge for stacking one said bucket inside another; said left side wall having an upper portion, said upper portion for containing implement painting end positioned on said second ledge from sliding leftward/peripherally and dripping paint outside said bucket;
(d) said second ledge having a horizontal edge; said second ledge edge positioned substantially at least ¾ inch horizontally centrally into said bucket; said second ledge edge substantially parallel with said right lip rim portion; said second ledge edge of a size and shape to support an implement flat-side; and said second ledge edge for supporting implement painting end; said right lip rim portion for supporting implement handle;
(e) and distance between said left side upper portion and said right lip rim portion being of a length to support implement painting end on said second ledge and implement handle on said right lip rim.

12. The bucket according to claim 10, wherein said first ledge edge substantially positioned 0.5″ to 1.5″ down and said first ledge protruding substantially at least 1 inch horizontally centrally into said bucket.

13. The bucket according to claim 10, wherein said second ledge edge substantially positioned 1.5″ to 3″ down and said first ledge protruding substantially at least 1 inch horizontally centrally into said bucket.

14. The bucket according to claim 10, wherein: said bucket lip substantially rectangular shaped, said rectangular shape for easy dipping of substantially wide implements into said bucket; said rectangular shape for laying implement handle on said right lip rim portion.

15. The bucket according to claim 10, wherein: said second ledge protruding substantially at least 1 inch horizontally centrally into said bucket.

16. The bucket according to claim 10, wherein: distance between upper portion of said left side wall and right side lip rim being less than 11″.

17. The bucket according to claim 10, wherein: L-shaped first ledge is substantially L-shaped at least 4″ front-to-back side depth.

18. The bucket according to claim 11, wherein: L-shaped second ledge is substantially L-shaped at least 4″ front-to-back side depth.
